(19) United States
(12) Patent Application Publication
(10) Pub. No.: US 2026/0327115 A1
(43) Pub. Date: Oct. 22, 2026

(54) AMMONIA REMOVAL SYSTEM

(71) Applicant: SAMSUNG ELECTRONICS CO., LTD., Suwon-si (KR)

(72) Inventors: Daeseon PARK, Suwon-si (KR); Kukjin SEO, Seongnam-si (KR); Kyungyong SHIN, Ansan-si (KR); Misam KANG, Yongin-si (KR); David KIM, Suwon-si (KR); Dongseoung SHIN, Suwon-si (KR); Inseo YOON, Suwon-si (KR); Hansol JANG, Suwon-si (KR); Jaehyun JUNG, Yongin-si (KR)

(73) Assignees: SAMSUNG ELECTRONICS CO., LTD., Suwon-si (KR); KURITA HANSU Water Industries, Ltd., Seongnam-si (KR)

(21) Appl. No.: 19/385,819

(22) Filed: Nov. 11, 2025

(30) Foreign Application Priority Data
Apr. 17, 2025 (KR) 10-2025-0050120

(51) Int. Cl. C02F 9/00; C02F 1/00; C02F 1/20; C02F 1/66; C02F 101/16

(52) U.S. Cl. CPC C02F 9/00; C02F 1/008; C02F 1/001; C02F 1/20; C02F 1/66; C02F 2101/16; C02F 2209/02; C02F 2209/06; C02F 2209/44; C02F 2301/046

(57) ABSTRACT

An embodiment of the present disclosure provides an ammonia removal system including: a preprocessor for preprocessing wastewater; a preprocessed water tank for storing the wastewater preprocessed by the preprocessor; a first separator device for receiving a portion of the preprocessed wastewater from the preprocessed water tank, converting the same into ammonia-removed first-processed water, and re-inputting the first-processed water to the preprocessed water tank; a second separator device for receiving the preprocessed wastewater not transmitted to the first separator device from among the preprocessed wastewater including the re-input first-processed water stored in the preprocessed water tank, and converting the same into ammonia-removed second-processed water; and an absorbent supply portion for supplying absorbent to the first separator device.

### CROSS-REFERENCE TO RELATED APPLICATION

This application claims priority to and the benefit of Korean Patent Application No. 10-2025-0050120 filed with the Korean Intellectual Property Office on Apr. 17, 2025, the entire contents of which are incorporated herein by reference.

### BACKGROUND

### 1. Field of the Invention

The present disclosure relates to an ammonia removal system.

### 2. Description of the Related Art

Conventionally used methods for removing ammonia in low concentration include a breakthrough chlorine injection method and an electrochemical oxidation method. However, in the case of wastewater with high concentration of ammonia, there is a drawback of incurring excessive costs.

Regarding wastewater including high concentration of ammonia, an absorption method using a scrubber is mainly used, but there are drawbacks in that excessive energy is consumed in the process of generating small water droplets, and a large space is required to secure a contact time between the water droplets and the ammonia gas.

Recently, transmembrane chemisorption (TMCS) is used as a method for removing ammonia. Transmembrane chemisorption is a technology for removing ammonia from a gas or aqueous solution including ammonia through an absorbent. The method uses a porous hydrophobic membrane, and when wastewater including ammonia and an absorbent are passed through the inside and outside of the porous hydrophobic membrane, respectively, it utilizes the principle that vaporized contaminants such as ammonia move in the absorbent direction through the pores of the membrane due to the concentration difference.

The transmembrane chemisorption has an effective contact area 30 times larger than that of a typical absorption process in the same volume, so it has a narrow site area compared to processing efficiency and is highly efficient in removing ammonia wastewater in high concentration.

### SUMMARY

The present disclosure relates to a method for recovering ammonia from wastewater using a separator device based on transmembrane chemisorption, and provides an ammonia removal system for increasing economic feasibility by reducing a processing temperature and an amount of processing chemicals compared to conventional air stripping or breakthrough chlorine injection methods. Additionally, the method may be performed in a compact indoor space.

The present disclosure provides an ammonia removal system for processing wastewater using separator devices comprising a first separator device to remove ammonia while circulating wastewater supplied by a tank and reducing a concentration of ammonia included in the wastewater stored in the tank, and a second separator device to receive the wastewater comprising the reduced concentration of ammonia and further remove additional ammonia, thereby minimizing the number of requisite separator devices while maximizing ammonia removal efficiency.

One or more embodiments of the present disclosure provides an ammonia removal system including: a preprocessor for preprocessing wastewater; a preprocessed water tank for storing the wastewater preprocessed by the preprocessor; a first separator device for receiving a portion of the preprocessed wastewater from the preprocessed water tank, converting the same into ammonia-removed first-processed water, and re-inputting the first-processed water to the preprocessed water tank; a second separator device for receiving the preprocessed wastewater not transmitted to the first separator device from among the preprocessed wastewater including the re-input first-processed water stored in the preprocessed water tank, and converting the same into ammonia-removed second-processed water; and an absorbent supply portion for supplying absorbent to the first separator device.

One or more embodiments of the present disclosure provides an ammonia removal system including: a wastewater tank for storing wastewater; a preprocessor for controlling pH of the wastewater and filtering the wastewater; a preprocessed water tank for storing wastewater preprocessed by the preprocessor; a first separator device for receiving a portion of the preprocessed wastewater, converting the same into ammonia-removed first-processed water using absorbent, and re-inputting the first-processed water to the preprocessed water tank; a second separator device for receiving the preprocessed wastewater not transmitted to the first separator device from among the preprocessed wastewater including the re-input first-processed water stored in the preprocessed water tank, and converting the same into ammonia-removed second-processed water using the absorbent transmitted from the first separator device; and an absorbent supply portion for providing the absorbent to the first separator device.

One or more embodiments of the present disclosure provides an ammonia removal system including: a wastewater tank for storing wastewater; a preprocessor for preprocessing the wastewater; a preprocessed water tank for storing wastewater preprocessed by the preprocessor; a first separator device for re-inputting first-processed water from which ammonia is removed using absorbent from a portion of the preprocessed wastewater transmitted by the preprocessed water tank to the preprocessed water tank; and a second separator device for receiving the preprocessed wastewater not transmitted to the first separator device from among the preprocessed wastewater including the re-input first-processed water from the preprocessed water tank, and removing ammonia using the absorbent.

One or more embodiments of the present disclosure may provide a method for recovering ammonia from wastewater using a separator device based on transmembrane chemisorption, and may provide an ammonia removal system for increasing economic feasibility by reducing a processing temperature and an amount of processing chemicals compared to conventional air stripping or breakthrough chlorine injection methods, and may provide installation in a compact indoor space.

One or more embodiments of the present disclosure, the ammonia removal system for processing wastewater using separator devices may allow a first separator device to remove ammonia while circulating wastewater supplied from a tank and reduce concentration of ammonia included in the wastewater stored in the tank, and may allow a second separator device to receive the ammonia-reduced wastewater in the tank and remove the ammonia, thereby minimizing the number of separator devices and maximizing the ammonia removal efficiency.

### BRIEF DESCRIPTION OF DRAWINGS

FIG. 1 shows an ammonia removal system according to an embodiment.

FIG. 2 shows an enlarged view on a first separator device of an ammonia removal system according to an embodiment.

FIG. 3 shows an enlarged view on a region S1 of FIG. 2.

FIG. 4 shows a process for processing ammonia in wastewater.

FIG. 5 shows an ammonia removal system according to another embodiment.

FIG. 6 shows an enlarged view on S2 of FIG. 5.

FIG. 7 shows a graph on changes of concentration of ammonia in a preprocessed water tank when a first separator device is driven in an ammonia removal system of FIG. 5.

FIG. 8 shows a graph on effects of ammonia removal system of FIG. 5.

### DETAILED DESCRIPTION

In the following detailed description, only certain embodiments of the present disclosure have been shown and described, simply by way of illustration. As those skilled in the art would realize, the described embodiments may be modified in various different ways, all without departing from the spirit or scope of the present disclosure.

The drawings and description are to be regarded as illustrative in nature and not restrictive, and like reference numerals designate like elements throughout the specification.

The size and thickness of each configuration shown in the drawings are arbitrarily shown for better understanding and ease of description. The present disclosure is not limited to what is shown. The thickness of layers, films, panels, regions, etc., are enlarged for clarity. The thicknesses of some layers and areas are exaggerated for better understanding and ease of description.

Throughout this specification and the claims that follow, when it is described that an element is “coupled” to another element, the element may be “directly coupled” to the other element or “indirectly coupled” to the other element through a third element. Unless explicitly described to the contrary, the word “comprise”, and variations such as “comprises” or “comprising”, will be understood to imply the inclusion of stated elements but not the exclusion of any other elements.

It will be understood that when an element such as a layer, film, region, or substrate is referred to as being “on” another element, it may be directly on the other element or intervening elements may also be present. In contrast, when an element is referred to as being “directly on” another element, there are no intervening elements present. The word “on” or “above” means positioned on or below the object portion, and does not necessarily mean positioned on the upper side of the object portion based on a gravitational direction.

The phrase “in a plan view” means viewing an object portion from the top, and the phrase “in a cross-sectional view” means viewing a cross-section of which the object portion is vertically cut from the side.

Throughout the specification, sequential numbers such as first and second are used to distinguish a constituent element from other constituent elements that are the same or similar to it, and are not necessarily intended to refer to a specific constituent element. Accordingly, a component referred to as the first constituent element in one part of this specification may be referred to as a second constituent element in another part of this specification.

References to any constituent element in the singular form may include references to a plurality of those constituent elements, unless specifically stated to the contrary. For example, an insulating layer may be used to mean not only one insulating layer, but also a plurality of insulating layers, such as two, three or more. Similarly, the component described as plural may be implemented as a single component.

The references to one side and the other side are intended to distinguish between different sides, and are not necessarily intended to limit it to a specific side. Accordingly, a side referred to as one side in a particular part of this specification may be referred to as the other side in other parts of this specification.

References to directions such as upper surface, upper side, upper part, lower surface, lower side, and lower part are intended to aid description and understanding with reference to the drawings.

Conventional methods for removing ammonia in low concentration (equal to or less than 20 mg/L) from water include a breakthrough chlorine injection method and an electrochemical oxidation method.

The breakthrough chlorine injection method represents a chemical method for removing ammonia. The method removes ammonia by injecting chlorine (Cl₂) into gas or an aqueous solution including ammonia. The chlorine reacts with ammonia to generate compounds such as ammonium chloride (NH₄Cl), which reduces a concentration of ammonia. However, the breakthrough chlorine injection method requires caution when handling due to toxicity of chlorine, and there is a problem that other additional chemical materials are generated if excessive chlorine is injected.

The electrochemical oxidation method oxidizes ammonia using electricity. The method involves passing a current through an electrode to oxidize ammonia (NH₃) and converting it into nitrogen and water, thereby reducing the ammonia concentration. However, the electrochemical oxidation method has drawbacks in that it requires maintenance of electrical equipment and electrodes, the initial installation cost of which is relatively high, and the efficiency of the system may vary depending on the electrode material and reaction conditions.

Recently, a method of air stripping or a scrubber method have been used as a method for removing ammonia in high concentrations of 100 mg/L or more.

Air stripping removes volatile contaminants including ammonia in wastewater through air flow. However, there are problems in that it requires a large process site and consumes high energy.

The scrubber method removes vaporized ammonia by absorbing it into water droplets including sulfuric acid. As the size of the water droplets decreases, the surface area for absorbing ammonia increases, so there are drawbacks in that a large amount of energy is required to create small water droplets and a large space is required to maintain them.

Accordingly, a technology for recovering ammonia from wastewater through a separator is developed based on transmembrane chemisorption (TMCS).

The transmembrane chemisorption flows wastewater including contaminants and an absorbent (sulfuric acid, phosphoric acid, formic acid, etc.) absorbing the contaminants across a membrane border including hydrophobic pores including a size of about 100 nm to about 1 μm. During this process, volatile contaminants such as ammonia diffuse from wastewater to the absorbent through the pores of the membrane due to the difference of concentration. The transmembrane chemisorption uses the principle of movement through the diffusion phenomenon.

The transmembrane chemisorption is a process performed in a membrane contactor, combining the merits of liquid absorption and membrane separation. An effective area for mass transfer may be significantly increased by using hydrophobic hollow fiber membrane bundles in the membrane contactor. In fact, it has the advantage of reducing the size of the unit process to be one tenth ( 1/10) that of conventional air stripping.

An ammonia removal system 10 according to one or more embodiments of the present disclosure using transmembrane chemisorption will now be described in detail with reference to drawings.

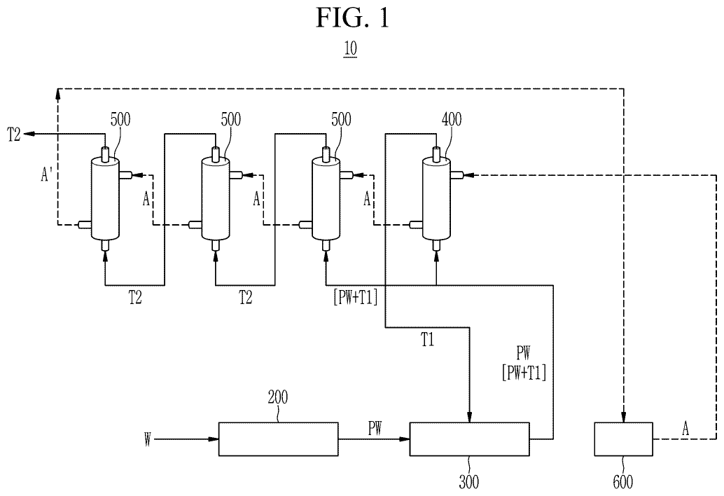

FIG. 1 shows an ammonia removal system according to an embodiment.

As shown in FIG. 1, the ammonia removal system 10 may include: a preprocessor 200 for preprocessing wastewater W; a preprocessed water tank 300 for storing wastewater PW preprocessed by the preprocessor 200; a first separator device 400 for converting a portion of the preprocessed wastewater PW into first-processed water T1 and re-inputting the first-processed water T1 to the preprocessed water tank 300; a second separator device 500 for receiving a portion of the preprocessed wastewater PW from the preprocessed water tank 300 and converting the same into ammonia-removed second-processed water T2; and an absorbent supply portion 600 for supplying absorbent A to the first separator device 400.

The first separator device 400 may receive a portion of the preprocessed wastewater PW from the preprocessed water tank 300, may convert the same into ammonia-removed first processed water T1, and may re-input the first-processed water T1 to the preprocessed water tank 300.

The second separator device 500 may receive the preprocessed wastewater PW including re-input first-processed water T1, which is not transmitted to the first separator device 400, from among the preprocessed wastewater PW stored in the preprocessed water tank 300 and including the re-input first-processed water T1, and may convert the same into ammonia-removed second-processed water T2.

For example, referring to FIG. 1, when a flow rate of the preprocessed wastewater PW discharged from the preprocessed water tank 300 is 10 m³/hr, the flow rate of the preprocessed wastewater PW moving to the first separator device 400 may be 5 m³/hr. The remaining 5 m³/hr may be moved to the second separator device 500.

The flow rate of 5 m³/hr moved to the first separator device 400 becomes the first-processed water T1 and is re-input to the preprocessed water tank 300, where it may be mixed with the preprocessed wastewater PW stored in the preprocessed water tank 300.

The ammonia removal system 10 may control the total amount of ammonia moving to the first separator device 400 and the second separator device 500 by controlling the respective flow rates of the preprocessed wastewater PW and the first-processed water T1 moving to the same.

Each of the pipes moving to the first separator device 400 and the second separator device 500 may further include a concentration meter for measuring concentration of ammonia, and may further include a valve for controlling the flow rates depending on the measured concentration of ammonia.

The first separator device 400 and the second separator device 500 in the ammonia removal system 10 may remove ammonia using the absorbent A.

As shown in FIG. 1, the absorbent A discharged from the first separator device 400 may be input to the second separator device 500, and the absorbent A′ discharged from the second separator device 500 may be re-input to the absorbent supply portion 600. The pH of the absorbent A used by the first separator device 400 may increase compared to the absorbent A before being input to the first separator device 400. This is the result of processing the preprocessed wastewater PW.

The ammonia removal system 10 may use a method for recovering ammonia from the wastewater W using the separator devices 400 and 500 including a separator 432 based on the transmembrane chemisorption. This has the advantage of being more economical than the conventional air stripping and the breakthrough chlorine injection method due to a lower processing temperature and reduced chemical usage, and may be installed in compact indoor spaces.

There is a method for increasing the number of separator devices connected in series to increase the ammonia removal rate.

However, when the number of separator devices is increased, the equipment volume increases, which in turn requires a larger indoor space. In addition, the manufacturing of separator devices requires a relatively high cost such that when the number of separator devices increases, the equipment costs may also increase. This may lead to lower economic feasibility.

The ammonia removal system 10 may process wastewater W using separator devices, while minimizing the number of second separator devices 500 coupled in series, and optimizing ammonia removal efficiency. As a result, the ammonia removal system 10 may minimize the equipment volume and the cost required for the equipment.

For this purpose, the preprocessed wastewater PW discharged from the preprocessed water tank 300 may not be directly coupled in series to the second separator devices 500. A portion of the preprocessed wastewater PW may be circulated through the first separator device 400 connected to the preprocessed water tank 300 to first remove ammonia, and then the ammonia-removed preprocessed wastewater PW may be delivered to the second separator devices 500, thereby further increasing the ammonia removal efficiency compared to the same number of separator devices.

In detail, the concentration of ammonia in the preprocessed water tank 300 may be controlled by controlling the retention time of the preprocessed wastewater PW in the first separator device 400

Among the separation membrane devices, the first separator device 400 may remove ammonia while circulating the preprocessed wastewater PW supplied from the preprocessed water tank 300, thereby reducing the concentration of ammonia included in the preprocessed wastewater PW stored in the preprocessed water tank 300.

The second separator device 500 may receive the preprocessed wastewater PW with reduced concentration of ammonia and may also remove additional ammonia, thereby increasing ammonia removal efficiency and maximizing the efficiency of the separator device.

The second separator devices 500 may be connected in series. When coupled in series, the contact time and area of the preprocessed wastewater PW and the separator 432 of the second separator device 500 may increase, thereby improving the ammonia removal efficiency.

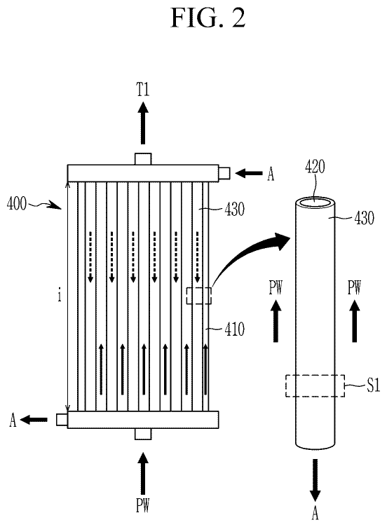

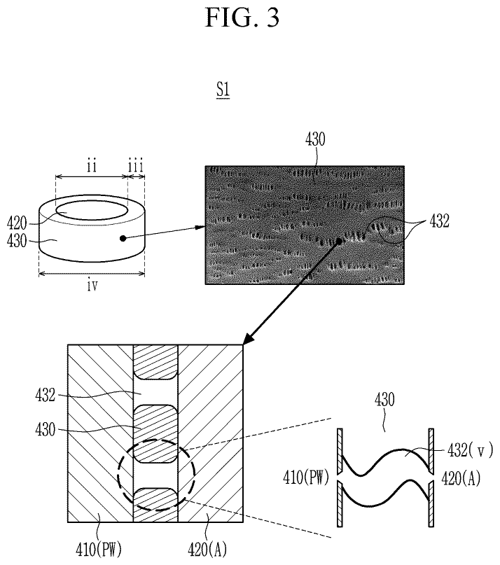

The first separator device 400 and the second separator device 500 will now be described in detail with reference to FIG. 2 and FIG. 3.

FIG. 2 shows an enlarged view of a first separator device 400 in an ammonia removal system according to an embodiment, and FIG. 3 shows an enlarged view of a region S1 of FIG. 2.

FIG. 2 and FIG. 3 show the first separator device 400, and the second separator device 500 may have the same structure as the first separator device 400.

Referring to FIG. 2 and FIG. 3, the first separator device 400 may include a wastewater mover 410, an absorber 420, and a separator 430.

The wastewater mover 410 in the first separator device 400 may represent a path on which the preprocessed wastewater PW moves.

The absorber 420 may be arranged parallel to the path along which the preprocessed wastewater PW moves and may include an absorbent A for absorbing ammonia from the preprocessed wastewater PW. The absorber 420 may be a path on which the absorbent A moves.

The separator 430 may be arranged between the wastewater mover 410 and the absorber 420 and may have pores 432 through which ammonia moves from the wastewater mover 410 toward the absorber 420. The separator 430 may be a path on which ammonia included in the preprocessed wastewater PW moves to the absorber 420.

The wastewater mover 410 in the second separator device 500 may be a path on which the preprocessed wastewater PW including the re-input first-processed water T1 moves.

The absorber 420 may be arranged in parallel to the path on which the preprocessed wastewater PW including the first-processed water T1 moves. The absorber 420 may include absorbent A for absorbing ammonia from the preprocessed wastewater PW including the first-processed water T1. That is, the absorber 420 may be a path on which the absorbent A moves.

The separator 430 is arranged between the wastewater mover 410 and the absorber 420 and may have pores 432 through which ammonia moves from the wastewater mover 410 toward the absorber 420. The separator 430 may be a path on which ammonia included in the preprocessed wastewater PW moves to the absorber 420.

As shown in FIG. 2 and FIG. 3, the wastewater mover 410 may have a pipe shape. In the wastewater mover 410, a hollow thin-walled pipe may be arranged in a direction parallel to the moving preprocessed wastewater PW, in which case the absorber 420 may represent an empty space of the thin pipe, and the separator 430 may mean the thickness of the thin pipe.

As shown in FIG. 2, the moving direction of the preprocessed wastewater PW may be opposite to the moving direction of the absorbent A.

As shown in FIG. 3, the separator 430 includes pores 432.

FIG. 2 and FIG. 3 show a length (i) of the separator 430, a diameter (ii) of the absorber 420, a thickness (iii) of the separator 430, a diameter (iv) of the separator 430, and curvature (v) of the pores 432. Curvature (v) of the pores 432 represents bending degrees of the pores 432.

The length (i) of the separator 430 refers to the length along the direction in which the preprocessed wastewater PW moves, that is, the length along the length direction of the separator 430 surrounding the absorber 420.

The thickness (iii) of the separator 430 refers to a vertical distance to an outer surface of the separator 430 from an outer surface of the absorbent portion 420 in the state of the separator 430 surrounding the absorbent portion 420.

Each structure described above may be a factor affecting the removal rate of ammonia in the first separator device 400.

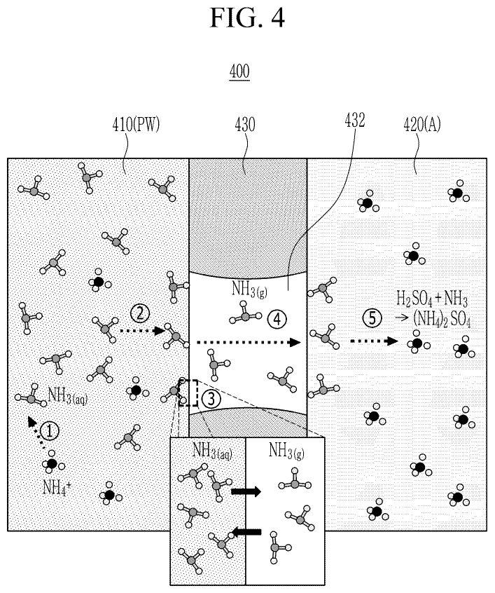

FIG. 4 shows a process for processing ammonia in wastewater. The drawing is given to illustrate the process of ammonia (NH₃) moving in the direction of the absorber 420 (or separator 430) in the wastewater mover 410 of the first separator device 400.

FIG. 4 shows an example of a process performed in the first separator device 400. The process performed in the second separator device 500 corresponds to what is described with reference to FIG. 4.

Referring to FIG. 2 to FIG. 4, the first separator device 400 may include: a wastewater mover 410 through which the preprocessed wastewater PW moves; an absorber 420 arranged along the path on which the preprocessed wastewater PW moves in the wastewater mover 410; and a separator 430 surrounding the absorber 420.

The absorber 420 may be arranged inside the separator 430 and may have a circular bar shape. The absorber 420 is not limited to the circular bar shape.

The absorber 420 may absorb ammonia from the preprocessed wastewater PW.

The absorbent A may move into the absorber 420. The absorbent A may include acid, and the ammonia having moved to the absorber 420 may react with the acid of the absorbent A and may form a nonvolatile compound. FIG. 4 shows sulfuric acid as the absorbent A, which may include nitric acid, phosphoric acid, formic acid, etc.

The multiple absorbers 420 may be arranged in the wastewater mover 410 (see FIG. 2). As the number of the arranged absorbers 420 increases, the amount of ammonia absorbed into the absorber 420 in the preprocessed wastewater PW may increase (see FIG. 2).

The separator 430 may include pores 432. The pores 432 may be a path on which ammonia moves from the wastewater mover 410 (see FIG. 3).

Referring to FIG. 4, ammonium ions (NH₄+) in the preprocessed wastewater PW included in the wastewater mover 410 mostly exist as ammonia (NH_{3(ag)}) at the high pH. Ammonia (NH_{3(g)}) is vaporized to the pores 432 of the separator 430, and the vaporized ammonia may be seen passing through the pores 432 and moving to the absorber 420.

Ammonia may exist in the preprocessed wastewater PW in the forms of ammonium ions (NH₄+) and ammonia (NH_{3(aq)}).

At the pH of 9 or higher, the ammonium ions (NH₄+) may change into the form of ammonia (NH_{3(aq)}), and at the pH of 11 or higher, more than 99% thereof exist as ammonia (NH_{3(aq)}) (see \textcircled{1}).

After being converted to ammonia at high pH, ammonia (NH_{3(aq)}) in water may change into ammonia gas (NH_{3(aq)}) while moving toward the pores 432 of the separator 430 according to Henry's law. Ammonia gas (NH_{3(g)}) may diffuse toward the pores 432 due to the difference of concentration (see \textcircled{2} and \textcircled{3}).

The ammonia (NH_{3(g)}) may move to the absorber 420 from the pores 432 (see \textcircled{4}), and may react with the acid (H₂SO₄) of the absorbent A stored in the absorber 420 to form a nonvolatile compound ((NH₄)₂SO₄) (see \textcircled{5}).

When the absorbent A is phosphoric acid (H₃PO₄), the nonvolatile compound may become (NH₄)₂HPO₄.

Referring to FIG. 4, the process for removing ammonia in the preprocessed wastewater PW, which is performed in the first separator device 400, may include: vaporizing ammonia (NH_{3(aq)}) in the wastewater mover 410; diffusing the vaporized ammonia (NH_{3(g)}) into the pores 432 of the separator 430; and adsorbing the diffused ammonia (NH_{3(g)}) into the absorber 420.

The ammonia removal rate may vary depending on the condition of the first separator device 400.

The condition of the first separator device 400 may include at least one of a length (i) of the separator 430, a diameter (ii) of the absorber 420, a thickness (iii) of the separator 430, an area (A) of the separator 430, and a size of the pores 432.

The area (A) of the separator 430 represents the area that the unit separator 430 surrounding the absorber 420 has when it is spread out. The unit separator 430 represents each separator 430 configuring separators 430 included in the first separator device 400.

The separator 430 is a hydrophobic material and may include polypropylene.

The area of the separator 430 may be 220 m². This may be obtained by multiplying horizontal lengths of the separators 430 that are spread out when the length (i) of the separator 430 is considered as a perpendicular length.

Depending on embodiments, an exterior diameter of the separator 430 may be 300 μm, and an interior diameter thereof may be 220 μm.

Depending on embodiments, the condition of the first separator device 400 may include at least one of an average diameter (dp) of the pores 432 of separators installed on the separator 430, porosity (ε), an internal volume (Vp), and curvature (τ) of the pores 432.

The internal volume (Vp) of the first separator device 400 represents a value obtained by subtracting the volume of the hollow-fiber-shaped separator 430 from the entire volume. That is, the internal volume (Vp) corresponds to the volume in which an actual flow of the preprocessed wastewater PW is generated from the first separator device 400.

The porosity (ε) of the separator 430 represents a ratio of the volume of the pores 432 in the unit volume of the separator 430. A porous membrane with a constant size of the pores 432 has the same area as the pores 432 on a surface of the membrane of the unit area, having a value between 0 and 1.

According to one or more embodiments, the pores 432 of the separator may have the size of 0.03 μm.

The conditions of the first separator device 400 will be referred to FIG. 2 and FIG. 3.

An ammonia removal process will now be described in detail with reference to FIG. 4.

Vaporizing of ammonia (NH_{3(aq)}) in the wastewater mover 410 may include changing ammonia (NH_{3(aq)}) from among ammonium ions (NH₄⁺) and ammonia (NH_{3(aq)}) existing in the preprocessed wastewater PW into ammonia gas (NH_{3(g)}) (see \textcircled{1}, \textcircled{2}, and \textcircled{3} in FIG. 4).

Diffusing the vaporized ammonia (NH_{3(g)}) to the pores 432 of the separator 430 is performed (see \textcircled{3} in FIG. 4). In this stage, the concentration of ammonia gas (NH_{3(g)}) diffused to the pores 432 may be calculated using the concentration of ammonia (NH_{3(aq)}) in the preprocessed wastewater PW, pH of the preprocessed wastewater PW, and temperatures as variables.

Diffusing of the vaporized ammonia (NH_{3(g)}) to the pores 432 of the separator 430 may include allowing air and ammonia gas (NH_{3(g)}) present in the pores 432 to reach equilibrium. In detail, it may be described that thermodynamic equilibrium is achieved according to Henry's law.

The ammonia gas (NH_{3(g)}) may not be saturated in the initial pores 432 of the separator 430. Hence, there may be a difference of concentration between the ammonia gas (NH_{3(g)}) in the wastewater mover 410 and the ammonia gas (NH_{3(g)}) in the pores 432. The ammonia gas (NH_{3(g)}) may move to a place of low concentration from a place of high concentration according to the law of diffusion. In this process, the curvature (τ) of the pores 432 and the diameter (dp) of the pores 432 give influences.

Adsorbing the diffused ammonia (NH_{3(g)}) to the absorber 420 may include moving the ammonia (NH_{3(g)}) having reached equilibrium in the pores 432 toward the absorber 420 from the pores 432 (see \textcircled{4} of FIG. 4).

It may also include allowing the ammonia (NH_{3(g)}) having moved to the absorber 420 to react with acid received in the separator 430 and form a nonvolatile compound (see \textcircled{5} of FIG. 4).

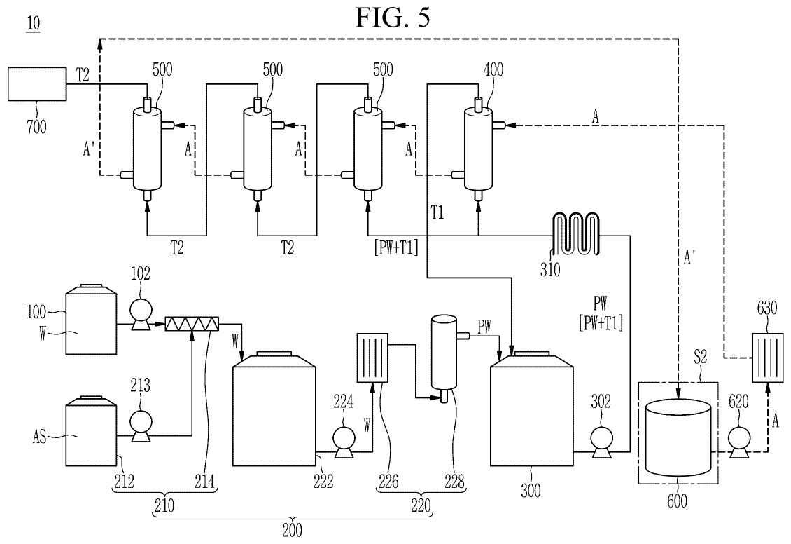

FIG. 5 shows an ammonia removal system according to an embodiment.

Referring to FIG. 5, the ammonia removal system 10 may include: a wastewater tank 100 for storing wastewater W; a preprocessor 200 for controlling pH of the wastewater W and filtering the wastewater W; a preprocessed water tank 300 for storing the wastewater PW preprocessed by the preprocessor 200; a first separator device 400; a second separator device 500; and an absorbent supply portion 600 for supplying absorbent A to the first separator device 400.

The first separator device 400 may receive a portion of the preprocessed wastewater PW, may convert the same into ammonia-removed first-processed water T1 using absorbent A, and may re-input the first-processed water T1 into the preprocessed water tank 300.

The second separator device 500 may receive the preprocessed wastewater PW that is not transmitted to the first separator device 400 from among the preprocessed wastewater PW including the re-input first-processed water T1, which may be stored in the preprocessed water tank 300, and may convert the same into ammonia-removed second-processed water T2 using the absorbent A transmitted from the first separator device 400. Furthermore, the second separator device 500 may include a plurality of second separator devices 500.

As shown in FIG. 5, the second separator device 500 may receive the absorbent A that is used by the first separator device 400 and is then discharged, and may then use it.

Depending on embodiments, the first separator device 400 may receive a portion of the preprocessed wastewater PW stored in the preprocessed water tank 300 and the re-input first-processed water T1 to remove ammonia therefrom, and may re-input resultant water to the preprocessed water tank 300. That is, the preprocessed wastewater PW stored in the preprocessed water tank 300 and the first-processed water T1 may be stored in a state in which ammonia has been removed multiple times by circulating through the first separation membrane device 400 multiple times. The ammonia may be removed multiple times, may be stored in the preprocessed water tank 300, and may be moved to the second separator device 500.

The concentration of ammonia in the preprocessed water tank 300 may be reduced by circulating the preprocessed wastewater PW in the preprocessed water tank 300 for more than a predetermined time (or a retention time) using a circulating separator device (or the first separator device 400). That is, when the first separator device 400 is operated for more than a predetermined time, the same effect as adding one more separator device coupled in series, such as the second separator device 500 may be obtained.

The ammonia removal system 10 may minimize the number of second separator devices 500 coupled in series, and may increase ammonia removal efficiency.

The preprocessor 200 may include a first preprocessor 210 for controlling pH of the wastewater W, and a second preprocessor 220 for filtering the wastewater W.

The first preprocessor 210 may include a solution storage tank 212 for storing a basic solution (AS), and a pH controller 214 for receiving the wastewater W and the basic solution (AS) and controlling pH of the wastewater W.

The pH controller 214 may mix the wastewater W and the basic solution (AS). The basic solution (AS) may include NaOH, but is not limited thereto.

The ammonia processing system 10 may further include a pH measuring device for measuring pH of the wastewater W mixed by the pH controller 214.

Depending on embodiments, the pH controller 214 may further include a valve arranged near the solution storage tank 212 to control the amount of the basic solution (AS) supplied according to pH of the wastewater W measured by the pH measuring device. It may control the amount of the supplied basic solution (AS) using the valve.

Regarding the ammonia included in the wastewater W, at the pH of 9 or higher, the ammonium ions (NH₄+) may change into the form of ammonia (NH_{3(aq)}), and at the pH of 11 or higher, more than 99% thereof exist as ammonia (NH_{3(aq)}).

Basicity of the wastewater W may be increased using the basic solution (AS) supplied by the first preprocessor 210. The purpose is to increase the ammonia removal rate by ensuring that a large amount of ammonia (NH_{3(aq)}) exists in the wastewater W

The wastewater W of which pH is controlled by the pH controller 214 of the first preprocessor 210 may move to the pH control preprocessed water tank 222. The pH-controlled wastewater W stored in the pH control preprocessed water tank 222 may move to the second preprocessor 220.

The second preprocessor 220 may include a first filter 226 for removing solid materials including suspended solids in the wastewater W.

The second preprocessor 220 may include a second filter 228 for removing fine solid materials in the wastewater W. The second filter 228 may use an ultrafiltration (UF) method.

The first filter 226 may remove the solid materials having a greater size of particles than the second filter 228. The solid materials with big particles may be removed before removing the fine solid materials. The fine solid materials may be solid materials with particles whose size is not removed by the first filter.

The ammonia removal system 10 may further include a temperature controller 310. The temperature controller 310 may control the temperature of the preprocessed wastewater PW discharged from the preprocessed water tank 300 and moving to the first separator device 400.

As shown in FIG. 5, the ammonia removal system 10 may further include a filtering portion 630 arranged between the absorbent supply portion 600 and the first separator device 400 and filtering the absorbent A proceeding to the first separator device 400. It may further include a pump 620 for applying pressure to the absorbent A supplied by the absorbent supply portion 600 so that the absorbent A stored in the absorbent supply portion 600 may move to the first separator device 400.

The ammonia removal system 10 may further include a pump 102 for applying pressure to the wastewater W stored in the wastewater tank 100 so that the wastewater W may move to the pH controller 214.

The ammonia removal system 10 may further include a pump 213 for applying pressure to the basic solution (AS) stored in the solution storage tank 212 so that the basic solution (AS) may move to the pH controller 214.

The ammonia removal system 10 may further include a pump 224 for applying pressure to the pH-controlled wastewater W stored in the pH control preprocessed water tank 222 so that the pH-controlled wastewater W may move to the second preprocessor 220.

The ammonia removal system 10 may further include a pump 302 for applying pressure to the preprocessed wastewater PW stored in the preprocessed water tank 300 so that the preprocessed wastewater PW may move to the first separator device 400. It may further include a processed water storage tank 700 for storing the second-processed water T2 discharged from the second separator device 500.

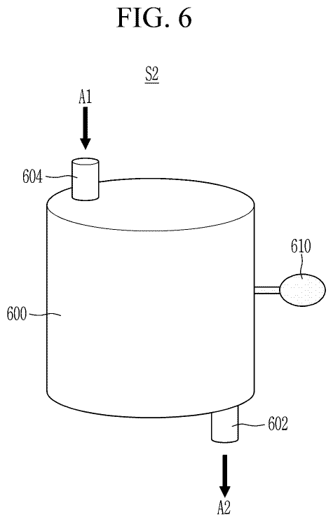

FIG. 6 shows an enlarged view on S2 of FIG. 5.

Referring to FIG. 6, the absorbent supply portion 600 may further include a pH measurement portion 610 for measuring pH of the absorbent A in the absorbent supply portion 600.

In detail, the absorbent A stored in the absorbent supply portion 600 may pass through the first separator device 400 and the second separator device 500 and may become the used absorbent A′.

The absorbent A may absorb the ammonia in the preprocessed wastewater PW and the first-processed water T1 while passing through the first separator device 400 and the second separator device 500. The pH of the absorbent A′ may increase. The used absorbent A′ may be re-input into the absorbent supply portion 600, and the used absorbent A′ may increase pH of the entire absorbent A stored in the absorbent supply portion 600.

Referring to FIG. 6, the new absorbent input into an inflow portion 604 is marked as A1, and the absorbent drained to the drainage portion 602 is marked as A2.

The ammonia removal system 10 may include a drainage portion 602 for draining the absorbent A2 stored in the absorbent supply portion 600 and used multiple times when the pH of the absorbent A2 (a mixed state of the used absorbent A′ and the unused absorbent A) stored in the absorbent supply portion 600 is substantially equal to or greater than a predetermined value. The ammonia removal system 10 may include an inflow portion 604 for inputting a new absorbent A1 into the absorbent supply portion 600.

According to one or more embodiments, when the concentration of the absorbent A2 stored in the absorbent supply portion 600 reaches 6 to 8 pH, the absorbent A2 may be drained, and the new absorbent A1 may be input.

The ammonia removal system 10 may control the concentration of ammonia in the preprocessed water tank 300 by controlling the retention time during which the preprocessed wastewater PW remains in the first separator device 400.

That is, the amount of ammonia included in the second-processed water T2 may be controlled by controlling the retention time during which the preprocessed wastewater PW stays in the first separator device 400. As a result, the ammonia removal rate in the wastewater W may be controlled.

The ammonia removal system 10 may reduce the concentration of ammonia in the preprocessed water tank 300 using one first separator device 400, and may move the preprocessed wastewater PW and the first-processed water T1 to the second separator devices 500 coupled in series, thereby minimizing the number of the separator devices 400 and 500, and increasing ammonia removal efficiency compared to the number of the separator devices 400 and 500.

To confirm the ammonia removal rate according to operating the ammonia removal system 10 including the first separator device 400 with one stage and the second separator device 500 with three stages, an experiment is performed in the conditions given in Table 1.

TABLE 1

| Items | Values |
|---|---|
| Separator material | Polypropylene |
| Valid film area (m²) | 220 |
| Separator exterior diameter (μm) | 300 |
| Separator interior diameter (μm) | 220 |
| Pore size (μm) | 0.03 |

As expressed in Table 1, the materials, the film areas, the exterior diameters, the interior diameters, and the pore sizes of the separator 430 of the first separator device 400 and the second separator device 500 are set to perform an experiment.

In the experiment, pH of the wastewater W is 11, and a flow rate of the preprocessed water wastewater PW is 10 m³/hr. The experiment is performed in the condition that the flow rate moving to the first separator device 400 and the second separator device 500 is 5 m³/hr

The temperature is controlled to be 27.5° C. by the temperature controller 310, the supplying flow rate of phosphoric acid as the absorbent A is 2 m³/hr, and the concentration of phosphoric acid is given as 20%.

As shown in FIG. 5, the result of performing the experiment for removing ammonia from the wastewater W using one first separator device 400 and three second separator devices 500 coupled in series is shown in Table 2.

In the experiment, initial concentration of ammonia-based nitrogen (NH₃—N) in the wastewater W is high (about 500 mg/L). The ammonia removal system 10 aims to minimize the number of the separator devices 400 and 500 and process ammonia-based nitrogen in high concentration.

TABLE 2

| | | Average ammonia | Ammonia removal rate |
|---|---|---|---|
| Number of stages of | | removal rate (%) for | (%) compared to |
| separator | | stages | wastewater |
| First | One | 40 | 40 |
| separator | stage | | |
| device | | | |
| Second | Two | 64 | 78 |
| separator | stages | | |
| device | Three | 64 | 92 |
| | stages | | |
| | Four | 60 | 97 or more |
| | stages | | |

According to the experiment result, as expressed in Table 2, as the number of the stages of the second separator device 500 increases, the ammonia removal rate (%) compared to the wastewater W increases.

Regarding the per-stage ammonia average removal rate (%), it is found that the ammonia removal rate is 40% while passing through the first separator device 400, and the ammonia removal rate is about 60% while passing through the second separator device 500.

According to the ammonia removal rate (%) of the separator devices 400 and 500 the second-processed water T2 having passed through the separator devices 400 and 500 with the total of four stages exhibits an ammonia removal rate of about 97% or more.

As the number of the stages of the second separator device 500 increases, the time during which the preprocessed wastewater PW contacts the separator 430 increases, the corresponding area increase, and the ammonia removal rate increases.

In case of using the separator devices 400 and 500 having a larger volume than the condition of the separator devices 400 and 500 described in Table 1 (in case of increasing the scale), the concentration of ammonia in the preprocessed wastewater PW and the first-processed water T1, which move to the second separator device 500 from the preprocessed water tank 300, may be controlled by controlling the retention time taken for the preprocessed wastewater PW to pass through the first separator device 400.

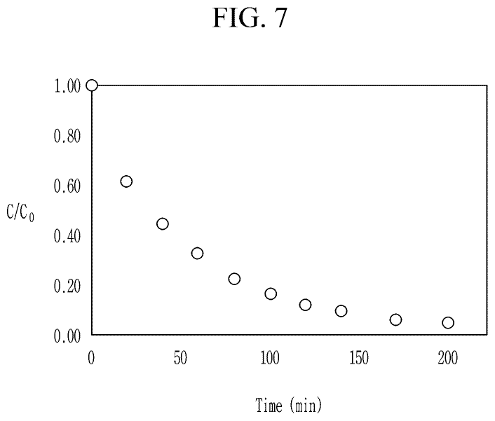

The change in the concentration of ammonia in the preprocessed water tank 300 according to the change in the retention time of the above preprocessed wastewater PW in the first separator device 400 will now be described with reference to in FIG. 7.

FIG. 1 and FIG. 5 show an ammonia removal system 10 including a first separator device 400 with a stage and a second separator device 500 with three stages. However, the ammonia removal system 10 according to the present disclosure is not limited to the number of the separator devices 400 and 500 shown in FIG. 1 and FIG. 5.

When the ammonia processing system 10 has a structure in which ammonia is first removed from the preprocessed wastewater PW in the first separator device 400, and is recovered and transmitted to the second separator devices 500 coupled in series, the number of the separator devices 400 and 500 is not limited.

That is, when the ammonia removal rate may be increased while minimizing the number of the separator devices 400 and 500 used, the number of the separator devices 400 and 500 included is not limited.

FIG. 7 shows changes in concentration of ammonia in a preprocessed water tank when a first separator device is operated in the ammonia removal system of FIG. 5. That is, FIG. 7 shows a graph on changes in concentration of ammonia in the preprocessed water tank 300 when the first separator device 400 is operated.

The driving conditions for the experiment in FIG. 7 are as follows.

At the start of operation, when the preprocessed water tank 300 is filled with a certain volume of the preprocessed wastewater PW, no more preprocessed wastewater PW is input to the preprocessed water tank 300 from the preprocessor 200.

The preprocessed wastewater PW stored in the preprocessed water tank 300 passes through the first separator device 400 to be converted into the first-processed water T1, and then is re-input into the preprocessed water tank 300. Other conditions are the same as in Table 1.

When driven under the above conditions, the concentration of ammonia in the preprocessed water tank 300, which changes over time, is as shown in FIG. 7.

Referring to FIG. 7, it may be seen that as time passes, the concentration (C) of ammonia in the first-processed water T1/concentration (C0) of ammonia in the initial preprocessed wastewater PW gradually decreases. That is, the concentration (C0) of ammonia in the initial preprocessed wastewater PW is constant, which means that the concentration (C) of ammonia in the first-processed water T1 decreases.

The ammonia processing system 10 may control the concentration of the first-processed water T1 stored in the preprocessed water tank 300 by controlling the retention time of the preprocessed wastewater PW in the first separator device 400. Regarding the graph, it may be confirmed that when operating with the retention time of approximately 50 minutes or more, the concentration of ammonia may be removed by more than 60%.

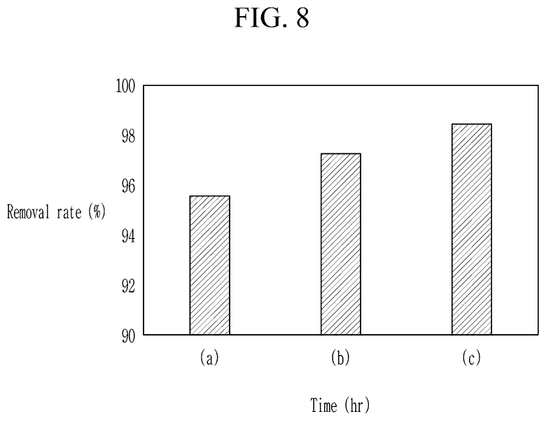

FIG. 8 shows a graph on the effectiveness of the ammonia removal system according to FIG. 5.

FIG. 8 (a) shows the ammonia removal rate when ammonia is removed using a three-stage second separator device 500, excluding the first separator device 400, in the ammonia removal system 10 according to FIG. 5.

FIG. 8 (b) shows the ammonia removal rate when ammonia is removed using a one-stage first separator device 400 and a three-stage second separator device 500 in the ammonia removal system 10 according to FIG. 5.

FIG. 8 (c) shows the ammonia removal rate when ammonia is removed using a four-stage second separator device 500, excluding the first separator device 400, in the ammonia removal system 10 according to FIG. 5.

Other conditions are the same as in Table 1.

As in (a) of FIG. 8, when the second separator device 500 with three stages coupled in series is used, the ammonia removal rate in each separator device 500 is confirmed to be approximately 65%. As a result, it may be confirmed that the ammonia removal rate is approximately 95% compared to the preprocessed wastewater PW.

As shown in (b) of FIG. 8, according to the present disclosure, in the case of using the first separator device with in one stage and the second separator device 500 with three stages, it may be confirmed that the ammonia removal rate is approximately 97% compared to the preprocessed wastewater PW.

As shown in (c) of FIG. 8, when the second separator device 500 with four stages coupled in series is used, it may be confirmed that the ammonia removal rate is approximately 98% compared to the preprocessed wastewater PW.

In an experiment like (c) of FIG. 8, the average ammonia removal rate (%) for each stage is sequentially 63%, 66%, 60%, and 57% from one stage to four stages, and the ammonia removal rate for each stage is confirmed to be approximately 60%. In addition, when coupled in series from one stage to four stages, the ammonia removal rate (%) compared to the preprocessed wastewater PW in each stage is confirmed to be 63%, 87%, 95%, and 97% or more.

Regarding (a) to (c) of FIG. 8, it may be seen that the ammonia removal rate increases as the number of stages increases. This is because as the number of the stages of the separator devices 400 and 500 increases, the time and area in which the preprocessed wastewater PW comes into contact with the separator 430 increase.

However, when comparing (b) and (c) of FIG. 8, it may be confirmed that although the ammonia removal rate of (c) of FIG. 8 is slightly higher than that of (b), the values are almost similar to each other. In both cases, the ammonia removal rate is over 97%.

The important point is that (b) of FIG. 8 according to the present disclosure takes less time than (c). That is, when using the ammonia removal system 10 according to the present disclosure ((b) of FIG. 8), the time required to secure a similar ammonia removal rate may be reduced compared to the case of using the separator device 500 with four stages coupled in series ((c) of FIG. 8).

Particularly, the number of the second separator devices 500 coupled in series in (b) of FIG. 8 is 3, which is significant because it minimizes the number of the second separator devices 500 coupled in series compared to (c) of FIG. 8 while securing a similar ammonia removal rate.

As described above, the ammonia removal system 10 according to the present disclosure includes: a wastewater tank 100 for storing wastewater W; a preprocessor 200 for preprocessing the wastewater W; a preprocessed water tank 300 for storing wastewater PW preprocessed by the preprocessor 200; a first separator device 400 for re-inputting first-processed water T1, from which ammonia is removed using absorbent A from some of the preprocessed wastewater PW transmitted from the preprocessed water tank 300, into the preprocessed water tank 300; and a second separator device 500 for receiving the preprocessed wastewater PW that is not transmitted to the first separator device 400 from among the preprocessed wastewater PW including the re-input first-processed water T1 from the preprocessed water tank 300, and removing ammonia using the absorbent A.

That is, the ammonia removal system 10 according to the present disclosure includes a first separator device 400 for removing ammonia while repeatedly circulating wastewater, and thereby lowering the concentration of ammonia included in the wastewater. The second separator device 500 receives wastewater with lower concentration of ammonia and removes ammonia, thereby minimizing the number of the second separator devices 500 coupled in series, improving the economic efficiency of the separator device, and maximizing the efficiency of the separator device by removing ammonia in a short period of time.

Although the embodiment of the present disclosure has been described in detail, the scope of the present disclosure is not limited by the embodiment. Various changes and modifications using the basic concept of the present disclosure defined in the accompanying claims by those skilled in the art shall be construed to belong to the scope of the present disclosure.

The embodiments of the present disclosure are not independent of each other and may be practiced in combination with each other unless specifically contradictory. Therefore, the embodiments that combine embodiments of the present disclosure should also be considered included in the present disclosure.

What is claimed is:

1. An ammonia removal system comprising:
a preprocessor configured to preprocess wastewater;
a preprocessed water tank configured to receive and store the wastewater preprocessed by the preprocessor;
a first separator device configured to:
receive a portion of the preprocessed wastewater from the preprocessed water tank,
convert the portion of the preprocessed wastewater into ammonia-removed first-processed water, and
re-input the ammonia-removed first-processed water into the preprocessed water tank;
a second separator device configured to:
receive the preprocessed wastewater not transmitted to the first separator device from among the preprocessed wastewater including the re-input first-processed water stored in the preprocessed water tank, and
convert the preprocessed wastewater not transmitted to the first separator device into ammonia-removed second-processed water; and
an absorbent supply portion configured to store absorbent and supply the absorbent to the first separator device.

2. The ammonia removal system of claim 1, wherein the first separator device and the second separator device are configured to remove ammonia using the absorbent.

3. The ammonia removal system of claim 1, wherein the first separator device is configured to discharge and input the absorbent into the second separator device.

4. The ammonia removal system of claim 3, wherein the second separator device is configured to discharge and re-input the absorbent into the absorbent supply portion.

5. The ammonia removal system of claim 1, further comprising a pH measurement portion configured to measure pH of the absorbent stored in the absorbent supply portion.

6. The ammonia removal system of claim 5, further comprising a drainage portion configured to drain the absorbent stored in the absorbent supply portion based on the pH being substantially equal to or greater than a predetermined reference; and
an inflow portion configured to input new absorbent into the absorbent supply portion.

7. The ammonia removal system of claim 1, further comprising a pump configured to move the absorbent to the first separator device.

8. The ammonia removal system of claim 1, further comprising a filtering portion between the absorbent supply portion and the first separator device, the filtering portion being configured to filter the absorbent.

9. The ammonia removal system of claim 1, comprising a temperature controller configured to control a temperature of the preprocessed wastewater received by the first separator device from the preprocessed water tank.

10. The ammonia removal system of claim 1, wherein the first separator device comprises:
a wastewater mover configured to move the preprocessed wastewater;
an absorber arranged in parallel to a path on which the preprocessed wastewater moves, and comprising the absorbent; and
a separator between the wastewater mover and the absorber, and comprising at least one pore configured to allow ammonia to move from the wastewater mover to the absorber.

11. The ammonia removal system of claim 1, wherein the second separator device comprises:
a wastewater mover configured to move preprocessed wastewater comprising the re-input ammonia-removed first-processed water;
an absorber arranged in parallel to a path on which the preprocessed wastewater comprising the re-input ammonia-removed first-processed water moves, and including the absorbent; and
a separator between the wastewater mover and the absorber, and including at least one pore configured to allow ammonia to move from the wastewater mover to the absorber.

12. The ammonia removal system of claim 1, wherein the preprocessor comprises:
a first preprocessor configured to control pH of the wastewater; and
a second preprocessor configured to filter the wastewater.

13. The ammonia removal system of claim 12, wherein the first preprocessor comprises:
a solution storage tank configured to store a basic solution; and
a pH controller configured to:
receive the wastewater and the basic solution; and
control pH in the wastewater.

14. The ammonia removal system of claim 12, wherein the second preprocessor comprises a first filter configured to remove a solid material comprising suspended solids in the wastewater.

15. The ammonia removal system of claim 12, wherein the second preprocessor comprises a second filter configured to remove a fine solid material in the wastewater.

16. An ammonia removal system comprising:
a wastewater tank configured to store wastewater;
a preprocessor configured to control pH of the wastewater and filter the wastewater;
a preprocessed water tank configured to store wastewater preprocessed by the preprocessor;
a first separator device configured to:
receive a portion of the preprocessed wastewater,
convert the portion of the preprocessed wastewater into ammonia-removed first-processed water using absorbent, and
re-input the ammonia-removed first-processed water into the preprocessed water tank;
a second separator device configured to:
receive at least a portion of the absorbent from the first separator device,
receive preprocessed wastewater not transmitted to the first separator device from among the preprocessed wastewater comprising the re-input ammonia-removed first-processed water stored in the preprocessed water tank, and
convert the preprocessed wastewater not transmitted to the first separator device into ammonia-removed second-processed water using the at least a portion of the absorbent received from the first separator device; and
an absorbent supply portion configured to provide the absorbent to the first separator device.

17. The ammonia removal system of claim 16, wherein a concentration of ammonia in the preprocessed water tank is controlled by controlling a retention time during which the preprocessed wastewater stays in the first separator device.

18. The ammonia removal system of claim 16, wherein the second separator device comprises a plurality of second separator devices connected in series.

19. The ammonia removal system of claim 16, further comprising a processed water storage tank configured to receive and store the ammonia-removed second-processed water from the second separator device.

20. An ammonia removal system comprising:
a wastewater tank configured to store wastewater;
a preprocessor configured to preprocess the wastewater;
a preprocessed water tank configured to store wastewater preprocessed by the preprocessor;
a first separator device configured to:
receive a portion of the preprocessed wastewater from the preprocessed water tank,
remove ammonia from the portion of the preprocessed wastewater using absorbent to produce ammonia-removed first-processed water, and
re-input the ammonia-removed first-processed water into the preprocessed water tank; and
a second separator device configured to:
receive preprocessed wastewater not transmitted to the first separator device from among the preprocessed wastewater comprising the re-input ammonia-removed first-processed water from the preprocessed water tank, and
remove ammonia from the preprocessed wastewater not transmitted to the first separator device using the absorbent.
